(19) United States
(12) Patent Application Publication
(10) Pub. No.: US 2016/0164899 A1
(43) Pub. Date: Jun. 9, 2016

(54) DATA-ORIENTED INFORMATION TECHNOLOGY SYSTEM

(71) Applicant: CHENGDU UNIVERSITY OF TECHNOLOGY, Chenghua, Sichuan (CN)

(72) Inventors: Fang MIAO, Chengdu (CN); Wenhui YANG, Chengdu (CN); Yiping LI, Chengdu (CN); Bing YU, Chengdu (CN); Xiangbing ZHOU, Chengdu (CN); Changxin SONG, Chengdu (CN)

(73) Assignee: CHENGDU UNIVERSITY OF TECHNOLOGY, Chengdu, Sichuan (CN)

(21) Appl. No.: 14/902,782

(22) PCT Filed: May 28, 2015
(86) PCT No.: PCT/CN2015/080013

§ 371 Date: Jan. 4, 2016

(30) Foreign Application Priority Data
Jul. 17, 2014 (CN) 201410341092.X

(51) Int. Cl. H04L 29/06

(52) U.S. Cl. CPC H04L 63/1425; H04L 63/1441

(57) ABSTRACT

A data-oriented information technology system has a data registration center, a data resource pool and a data service unit layer. The data resource pool is a space for storing data; the data registration center is used for constructing uniform data definition, naming and registration functions to realize data management; the data service unit layer includes a plurality of data-oriented, relevant function-encapsulated data function units, and data function units are used for accessing data in the data resource pool; when they first accesses the data resource pool, when the data registration center takes the initiative to refresh the information and informs the data function units, and when abnormalities occur during accessing, it is necessary to obtain information required for access from the data registration center, so that they can access data in the data resource pool.

### TECHNICAL FIELD

The invention relates to an information technology system, specifically a data-oriented information technology system.

### BACKGROUND

With the rise and application of cloud computing, Internet of Things and other technologies, data is constantly increasing and accumulating at an unprecedented rate, and increasingly occurs in specific application programs or information systems in form of tremendous data size, diversified data types and complex and variable data correlation, etc.

The existing information system takes a data processing way of solidifying logic relationship to bind application logic with data. As the development cycle of the system is long, when demand changes, it is usually needed to modify organization structure of the data, which will cause a series of problems such as code modification, test, redeployment, etc, further resulting in low efficiency of response to demand change and high maintenance cost, and it is difficult to meet requirements of practical application. In addition, due to different construction time and different developers, it results in that each application system has a separate data source, data among heterogeneous systems can not be connected, many “information islands” are created over a long time, or the data presents massive redundancy and ambiguity, and later it will take a large cost to perform data consolidation and application consolidation work.

When realized, the information system has dispersibility and evolutiveness, the system framework is difficult to be completely designed at an early stage, the existing system has high integration difficulty during the realization process, and is usually indirectly connected with the target, the system is difficult to support the integral strategical target, and as time goes on and the scale of the information system increases constantly, problems such as unreasonable system structure, imbalance of various parts, etc. will become increasingly prominent.

### SUMMARY OF THE INVENTION

An object of the invention is to overcome disadvantages of the prior art, and to provide a data-oriented information technology system, and the application system constructed therewith has high response efficiency and low maintenance cost and facilitates data sharing and expansion of system functions.

The invention solves above problems mainly by the following the technical scheme: a data-oriented information technology system, comprises a data registration center, a data resource pool and a data service unit layer, wherein: the data resource pool is a space for storing data; the data registration center is used for constructing uniform data definition, naming and registration functions to realize data management; and the data service unit layer comprises a plurality of data-oriented, relevant function-encapsulated data function units, the data function units are used for accessing data in the data resource pool, when they first accesses the data resource pool, when the data registration center takes the initiative to refresh the information and informs the data function units, and when abnormalities occur during accessing, it is necessary to obtain information required for access from the data registration center, and then to access data in the data resource pool. Data stored in the data resource pool of the invention can be any type of data, including but not limited to structured/non-structured data, real time/archived/historical data, and spatial/non-spatial data. The data resource pool is a space for storing data, its realization is independent of particular software, hardware platform or system, and only requires to realize storability, accessibility and expandability of data, and through the information stated by the data registration center, initiator of data access (such as a certain data function unit) can access data in the data pool. In order to construct uniform data definition, naming and registration functions, the data registration center of the invention should be provided therein with data standard, data classification, registration method, data index, retrieval, distributed management, operation modules, etc. The data function units of the invention determine data required to be accessed and logical processing rules for the accessed data according to specific application, wherein, the logical processing rules are semantic rules, relational association rules, logical relationship rules, style rules, etc. When the invention is applied, each data function unit can provide different functions according to different data types, and the data function units provide supports in terms of data, logic, exhibition and the like for building and operation of the application system.

In application and development of the existing information system, data is directly managed by the database system, the application itself does not manage data, which results in that when demand changes, it often needs to change database design. In terms of authority control, it is usual to perform function module control against the roles, namely the category of roles determines function that can be used, but not to perform authority control against the data itself, which will result in that when data leave the application (for example, database is maliciously attacked, etc.), serious security problems will occur. Further, a data-oriented information technology system further comprises a data authority center for accessing data in the data resource pool and controlling access authority, said data function units send information required for access to the data authority center, and the data authority center performs access to specific data in accordance with the information stated by the data registration center and feeds access results back to the data function units. In specific setting of the invention, the data authority center is provided therein with user authentication, user authorization, data attribute setting, data authority setting, data encryption, data decryption modules, etc., and the data authority center is used for acquiring data, transmitting data, storing data, managing data, dispatching data and controlling data authority. When the data function units of the invention acquire data in the data resource pool, accessing and controlling of data is realized by the data authority center, which can improve security of data.

Further, said data definition and data naming are to set attributes or features of data by using default rules, and said data registration realizes recording of information required when accessing data. Wherein, the set attributes or features of data include, but are not limited to, classification standard, storage location, access authority, etc., information required when accessing data can be storage address, access protocol of data and other information, and the data can be accessed after the initiator of data access acquires the information.

Further, said data registration center defines and registers various types of data by using metadata. When defining and registering various types of data by using metadata, the data registration center is also provided therein with metadata standard, metadata classification, metadata index modules, etc., and the data registration center takes the registration and management way with metadata as the core.

In order to improve expandability of the data resource pool, further, said data resource pool is realized by way of cloud storage.

Further, said data service unit layer also comprises any one unit or a combination of two units of a plurality of data service units and a plurality of data combination units for providing service aggregation, wherein, the data service units are used for providing service support interfaces of different demands by way of service and push. The invention when applied can construct data service units and data combination units in view of generality of conventional applications, and make operation more convenient while constructing the application system.

Further, said data service unit layer also comprises any one unit or a combination of multiple units of a plurality of data access units for providing data access, a plurality of data user units for providing visualization user interface, and a plurality of data processing units for integrating specific data processing functions according to application demands. Wherein, the data function units and the data access units of the invention are used for realizing data access as required, and the both are relatively basic components in the data service layer; and in specific setting of the invention, each data processing unit can integrate some special data processing functions in view of specific application demands.

Further, a data-oriented information technology system also comprises a data abnormality handling center for handling abnormalities occurring during accessing data, and said data abnormality handling center is used for detecting various abnormalities, and taking corresponding abnormality handling actions towards the abnormalities according to a set handling mechanism. Wherein, the data abnormality handling center comprises polling, abnormality and inconsistency detection, synchronous processing, redundancy processing, load balancing modules, etc. The data abnormality handling center handles abnormalities occurring during accessing data, and the handling mechanism should be considered to be capable of implementing a sum of various realization ways and methods.

Further, said abnormality handling actions includes sending abnormal signals, replacing abnormal data with preliminary data and requesting the data registration center to refresh corresponding information.

In conclusion, the invention has the following beneficial effects: (1) the data function units of the invention are basic component units of the application system, personalized system applications can be built from the simple to the complicated and from the easier to the more advanced through reasonable combination of a plurality of data function units, and rapidly respond to requirement for flexible access to data, and the application itself is also made flexibly expandable and can adjust functions as required, as such, the invention has convenient operation while expanding the system functions.

(2) The invention when applied can build the application by combination of data function units one another based on the data resource pool according to data access authority corresponding to the roles, naturally has flexible expandability, gets rid of dependence on specific ways, can build, modify and expand required application by itself, really does it as required and rapidly responds to demands.

(3) The data function units of the invention are data-oriented, relevant function-encapsulated, the data function units provides support in terms of logics for building and operation of the system application, the application logics and the data are not in the relationship of solidified binding, all applications are based on uniform data resource pool, the same data can be used under reasonable authority control by a plurality of built system applications, which fundamentally ensures that there are no longer problems such as “information islands”, massive data redundancy and ambiguity, etc.

(4) The invention when applied can perform role access authority control based on data itself through the data authority center, breaks the tradition of performing authority control with the function as the unit, can also provide access authority control for the data based on exclusive attribute of itself (such as life cycle and application environment), and can better adapt to and meet the requirement of data security in an open environment in a big data era of cloud computing.

(5) The invention when applied can avoid the problem in the existing information system that when demand changes, data structure is altered, but corresponding part of the application program is not accordingly altered to bring about system crash, and can avoid the security problem in the existing information system which occurs when the data leave the application (for example, database is maliciously attacked, etc.).

### BRIEF DESCRIPTION OF THE DRAWINGS

FIG. 1 is a structural representation of a specific example of the invention when applied.

### DETAILED DESCRIPTION OF THE PREFERRED EMBODIMENT

The invention will be further illustrated in detail below in conjunction with examples and drawings attached, but the embodiments of the invention are not limited thereto.

### Example 1

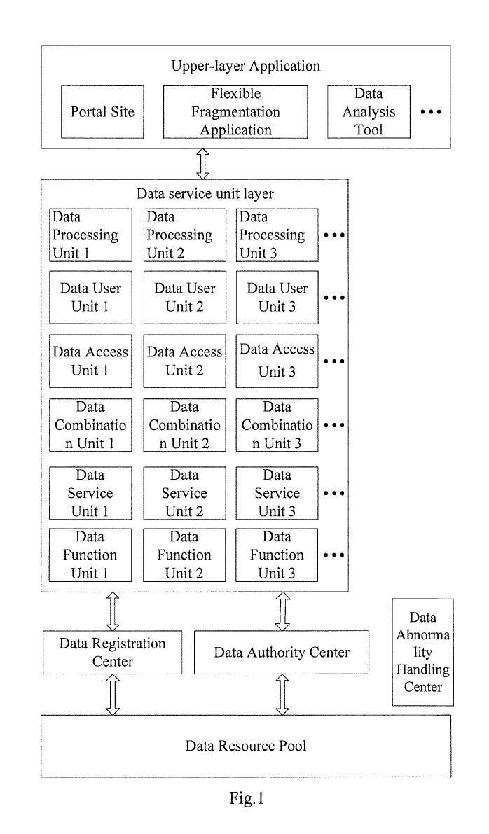

As shown in FIG. 1, a data-oriented information technology system, comprises a data registration center, a data resource pool and a data service unit layer, wherein, the data resource pool is a space for storing data, and data stored in the data resource pool can be any type of data, including but not limited to structured/non-structured data, real time/archived/historical data, and spatial/non-spatial data. The data resource pool of this example is realized by way of cloud computing and has storability, accessibility and expandability. The data registration center is used for constructing uniform data definition, naming and registration functions to realize data management. Data definition and data naming are to set attributes or features of data by using default rules, and these attributes or features includes, but are not limited to, classification standard, storage location, access authority, etc.; data registration realizes recording of information required when accessing data, the information can be storage address, access protocol of data and other information, and the data can be accessed after the initiator of data access acquires theses information. The data registration center of this example defines and registers various types of data by using metadata, and the data registration center comprises a data standard module, a data classification module, a metadata classification module, a registration method module, a data index module, a metadata index module, a retrieval module as well as a distributed management and operation module. The data resource pool of this example is a data storage space which can be recognized and managed by the data registration center, after the data is registered by the data registration center, the data has particular access features relative to the access initiator, and these features are definable and changeable features.

The data service unit layer comprises a plurality of data-oriented, relevant function-encapsulated data function units, and the data function units determine data required to be accessed and logical processing rules for the accessed data according to specific application, wherein, the logical processing rules are semantic rules, relational association rules, logical relationship rules, style rules, etc. The data function units of this example are used for accessing data in the data resource pool, they acquire relevant information from the data registration center when they first accesses, the data function units perform subsequent data access after possessing the information, and this access may be performed several times, until the data registration center takes the initiative to refresh the information and informs the data function units or abnormalities occur during accessing, etc, namely just in particular cases the data function units will need to acquire information again from the data registration center.

This example when applied can build personalized upper-layer applications from the simple to the complicated and from the easier to the more advanced through block combination of a plurality of data function units, wherein, the upper-layer applications are portal sites, flexible fragmentation applications, data analysis tools, etc., the upper-layer applications are dynamic expandable applications, convert business-oriented logic to data-oriented logic, and can combine small data-oriented application systems into a large business-oriented system.

### Example 2

In order to improve security in data access, this example further makes the following limitations on the basis of Example 1: this example further comprises a data authority center, wherein, the data authority center of this example comprises user an authentication module, a user authorization module, a data attribute setting module, a data authority setting module, a data encryption module and a data decryption module, and the data authority center accesses the data in the data resource pool and control the access authority. The data authority center of this example is used for acquiring data, transmitting data, storing data, managing data, dispatching data and controlling data authority, so as to realize access and control of the data. When the data function units of this example access the data in the data resource pool, the data function units send the information required for access to the data authority center, and the data authority center performs access to specific data in accordance with the information stated by the data registration center and feeds access results back to the data function units. When this example is applied, the data function units perform subsequent data access with the support of the data authority center.

### Example 3

This example further makes the following limitations on the basis of Example 1 or Example 2: the data service unit layer of this example further comprises any one unit or a combination of multiple units of a plurality of data service units, a plurality of data combination units for providing service aggregation, a plurality of data access units for providing data access, a plurality of data user units for providing visualization user interface, and a plurality of data processing units for integrating specific data processing functions according to application demands, wherein, the data service units are used for providing service support interfaces of different demands by way of service and push. Each unit of the data service layer in this example can be realized by application programming interface, and specifically the application can also be constructed by the data service units, the data combination units, the data access units, the data user units and the data processing units.

### Example 4

This example further makes the following limitations on the basis of any one of Examples 1-3: this example further comprises a data abnormality handling center, the data abnormality handling center comprises a polling module, an abnormality and inconsistency detection module, a synchronous processing module, a redundancy processing module and a load balancing module, and the data abnormality handling center of this example is used for handling abnormalities occurring during accessing data. When this example is applied, the data abnormality handling center is used for detecting various abnormalities, and taking corresponding abnormality handling actions towards the abnormalities according to a set handling mechanism. Wherein, the abnormality handling actions includes sending abnormal signals, replacing abnormal data with preliminary data and requesting the data registration center to refresh corresponding information, and the handling mechanism is a sum of various realization ways and methods for realizing abnormality handling.

As described above, the invention can be realized better.

1. A data-oriented information technology system, comprising a data registration center, a data resource pool and a data service unit layer, wherein: the data resource pool is a space for storing data; the data registration center is used for constructing uniform data definition, naming and registration functions to realize data management; and the data service unit layer comprises a plurality of data-oriented, relevant function-encapsulated data function units, the data function units are used for accessing data in the data resource pool, when they first accesses the data resource pool, when the data registration center takes the initiative to refresh the information and informs the data function units, and when abnormalities occur during accessing, it is necessary to obtain information required for access from the data registration center, and then to access data in the data resource pool.

2. The data-oriented information technology system according to claim 1, further comprising a data authority center for accessing data in the data resource pool and controlling access authority, said data function units send information required for access to the data authority center, and the data authority center performs access to specific data in accordance with the information stated by the data registration center and feeds access results back to the data function units.

3. The data-oriented information technology system according to claim 1, wherein, said data definition and data naming are to set attributes or features of data by using default rules, and said data registration realizes recording of information required when accessing data.

4. The data-oriented information technology system according to claim 1, wherein, said data registration center defines and registers various types of data by using metadata.

5. The data-oriented information technology system according to claim 1, wherein, said data resource pool is realized by way of cloud storage.

6. The data-oriented information technology system according to claim 1, wherein, said data service unit layer further comprises any one unit or a combination of two units of a plurality of data service units and a plurality of data combination units for providing service aggregation, wherein, the data service units are used for providing service support interfaces of different demands by way of service and push.

7. The data-oriented information technology system according to claim 1, wherein, said data service unit layer further comprises any one unit or a combination of multiple units of a plurality of data access units for providing data access, a plurality of data user units for providing visualization user interface, and a plurality of data processing units for integrating specific data processing functions according to application demands.

8. The data-oriented information technology system according to claim 1, further comprising a data abnormality handling center for handling abnormalities occurring during accessing data, said data abnormality handling center is used for detecting various abnormalities, and taking corresponding abnormality handling actions towards the abnormalities according to a set handling mechanism.

9. The data-oriented information technology system according to claim 8, wherein, said abnormality handling actions includes sending abnormal signals, replacing abnormal data with preliminary data and requesting the data registration center to refresh corresponding information.

10. The data-oriented information technology system according to claim 2, further comprising a data abnormality handling center for handling abnormalities occurring during accessing data, said data abnormality handling center is used for detecting various abnormalities, and taking corresponding abnormality handling actions towards the abnormalities according to a set handling mechanism.

11. The data-oriented information technology system according to claim 3, further comprising a data abnormality handling center for handling abnormalities occurring during accessing data, said data abnormality handling center is used for detecting various abnormalities, and taking corresponding abnormality handling actions towards the abnormalities according to a set handling mechanism.

12. The data-oriented information technology system according to claim 4, further comprising a data abnormality handling center for handling abnormalities occurring during accessing data, said data abnormality handling center is used for detecting various abnormalities, and taking corresponding abnormality handling actions towards the abnormalities according to a set handling mechanism.

13. The data-oriented information technology system according to claim 5, further comprising a data abnormality handling center for handling abnormalities occurring during accessing data, said data abnormality handling center is used for detecting various abnormalities, and taking corresponding abnormality handling actions towards the abnormalities according to a set handling mechanism.

14. The data-oriented information technology system according to claim 6, further comprising a data abnormality handling center for handling abnormalities occurring during accessing data, said data abnormality handling center is used for detecting various abnormalities, and taking corresponding abnormality handling actions towards the abnormalities according to a set handling mechanism.

15. The data-oriented information technology system according to claim 7, further comprising a data abnormality handling center for handling abnormalities occurring during accessing data, said data abnormality handling center is used for detecting various abnormalities, and taking corresponding abnormality handling actions towards the abnormalities according to a set handling mechanism.

16. The data-oriented information technology system according to claim 10, wherein, said abnormality handling actions includes sending abnormal signals, replacing abnormal data with preliminary data and requesting the data registration center to refresh corresponding information.

17. The data-oriented information technology system according to claim 11, wherein, said abnormality handling actions includes sending abnormal signals, replacing abnormal data with preliminary data and requesting the data registration center to refresh corresponding information.

18. The data-oriented information technology system according to claim 12, wherein, said abnormality handling actions includes sending abnormal signals, replacing abnormal data with preliminary data and requesting the data registration center to refresh corresponding information.

19. The data-oriented information technology system according to claim 13, wherein, said abnormality handling actions includes sending abnormal signals, replacing abnormal data with preliminary data and requesting the data registration center to refresh corresponding information.

20. The data-oriented information technology system according to claim 14, wherein, said abnormality handling actions includes sending abnormal signals, replacing abnormal data with preliminary data and requesting the data registration center to refresh corresponding information.
